(19) United States
(12) Patent Application Publication
(10) Pub. No.: US 2008/0052639 A1
(43) Pub. Date: Feb. 28, 2008

(54) Method and System for Providing Personalized Menu Page in Wireless Internet

(76) Inventors: Sung Hoon Chun, Seoul (KR); Jeong Hwan Ko, Seoul (KR)

Correspondence Address: MCDERMOTT WILL & EMERY LLP, 600 13TH STREET, N.W., WASHINGTON, DC, 20005-3096, US

(21) Appl. No.: 10/585,455

(22) PCT Filed: Jan. 5, 2005
(86) PCT No.: PCT/KR05/00014

§ 371 Date: Jul. 7, 2006

(30) Foreign Application Priority Data
Jan. 8, 2004 (KR) 10-2004-0001317

(51) Int. Cl. G06F 3/048

(52) U.S. Cl. 715/810

(57) ABSTRACT

The present invention relates to method and system for providing a personalized menu page, wherein the personalized menu page, in case that a user gets access to the wireless Internet by using a mobile communication terminal, has enhanced accessibility to a menu which the User has used most frequently at the relevant location during the relevant time, by grasping time information and the user's site information.

### TECHNICAL FIELD

The present invention relates to method and system for providing a personalized menu page on the wireless Internet by using a mobile communication terminal. More particularly, the present invention relates to method and system for providing a personalized menu page, wherein the personalized menu page, in case that a user gets access to the wireless Internet by using a mobile communication terminal, has enhanced accessibility to a menu which the user has used most frequently at the relevant location during the relevant time, by grasping time information and the user's location information.

### BACKGROUND ART

Recently, mobile communication terminals such as cellular phones, PCSs, PDAs, smart phones, handsets, web TVs and the like are useful in carrying and getting access to the wireless Internet at the same time, so as to obtain variety of information as a type of characters or images. Moreover, since the CDMA-2000 network or the IMT-2000 network is commercialized and delivered, the latest wireless internet service also provides multimedia information such as moving pictures, besides information formed of characters or images.

Most of current data services provided by mobile communication enablers and contents providers (CP) are performed through the wireless Internet based on wireless application protocol (WAP). Currently, the mobile communication terminal using the wireless Internet is optimized mainly for purpose of voice communication and the size of display is small. Thus, only a little piece of information can be displayed at one time. In addition, it is inconvenient because a small keypad or a touch screen is only an input means. Accordingly, information of the wireless Internet depends on a directory-based menu method.

Especially, as aforementioned, where contents providers (CP) embodies directory-based hierarchical menus by considering that the display or keypad of mobile communication terminal is small, it is ordinary that the number of selection items included in each of menus is reduced, so as to get access to a wanted content through several steps.

FIG. 1a is a diagram illustrating configuration of hierarchical menus which are generally adopted in the wireless Internet.

As shown in FIG. 1a, menus of the wireless Internet are formed in such a way that a plurality of menu nodes is arranged in a hierarchical structure. Herein, as the menu node corresponds to one location in the entire menu tree, it means a page for selection of menus in the middle step for going to a content that a user wants. Each menu node includes lower nodes, wherein the lowest node includes a menu of contents. In FIG 1a, D1, E1, E2, F1, F2, and GI mean menus of contents, and A, B, C, D, E, F, and G mean menu nodes. Moreover, like E2, some menus of comprise variety of menu nodes for access. A user has to go through A to G menu nodes, in order to get access to a content that the user wants. Each menu node has structure, in which menu nodes sequentially separate into B and C at A, into D and E at B, and F and G at C.

FIG. 1b is screens of mobile communication terminal showing procedures of getting access to contents through configuration of general hierarchical menu in the wireless Internet.

A user gets access to the wireless Internet through an Internet access menu, such as for example, ‘NATE’ of SK Telecom, ‘Magic-N’ of KTF, ‘Ez-i’ of LG Telecom, or the like, by using a mobile communication terminal. In case that a menu screen by the first menu node appears as illustrated in IA, the user selects a directory including contents that the user wants by using a keypad of the mobile communication terminal. In case that the directory is selected through the first menu node, a menu screen by a lower menu node appears. For example, in case that ‘3. picture/photo/broadcasting’ is selected in IA of the first menu screen, the lower menu screen appears as shown in IB. In case that ‘3. picture friend’ is selected, a menu screen by a lower menu node thereof appears. In case that the current menu node is lowest, each of contents connected thereto is displayed.

1C in FIG 1b is a screen by the lowest menu node. In case that ‘2. picture of birds’ is selected as shown in IC, a corresponding content is displayed in a type of characters, pictures, or moving pictures. Only if the user selects any one among the displayed characters, pictures, or moving pictures, a corresponding content is executed on the mobile communication terminal.

According to a menu system like above, in order to use particular contents, the user gets access to contents that the user wants through procedures of multi-staged menu selection/confirmation in accordance with a menu system provided as same every time. Especially, in case that contents that the user uses frequently are several, the user has to repeat procedures of menu selection/confirmation by going back to a higher menu.

In order to delete the repeated procedures like above and draw a user's convenience, a shortcut method and a link ranking method are developed and used for a method of constituting menus of the wireless Internet.

The shortcut is to additionally provide a route that is directly connected to a content of a higher menu node, based on the frequency and the time that the user uses the content. The shortcut may be automatically generated through a wireless service and may be manually registered through My page or Shortcut that is connected in such a way that the user registers contents that the user frequently uses.

FIG. 2a is a diagram illustrating configuration of menus by a shortcut method in the wireless Internet.

As illustrated in FIG. 2a, structure by a shortcut method of FIG. 2a is displayed as same as general structure of FIG la. At this time, a shortcut route is included in several menu nodes. In FIG. 2a, shortcut routes to E2 and GI are connected at A menu node, a shortcut route to E2 at B menu node, and a shortcut route to GI at C menu node. Like A, each menu node may have a plurality of shortcuts.

FIG. 2b is screens of mobile communication terminal showing procedures of getting access to contents through configuration of shortcut menus in the wireless Internet.

In case that a user gets access to the wireless Internet by using the mobile communication terminal, a menu screen by the first menu node is displayed as shown in 2A. At this time, shortcut routes are also displayed. That is, shortcuts to ‘picture of birds’ and ‘live broadcasting’ are included in a menu of ‘3. picture/photo/broadcasting’.

The user selects a shortcut that is directly connected to contents by using a keypad of mobile communication terminal, or selects a lower directory including contents that the user wants. In case that the user selects a lower directory of ‘3. picture/photo/broadcasting’ in 2A, a screen by a lower menu node is displayed as shown in 2B. In case that the user selects ‘picture of birds’, a shortcut menu, as shown in 2B, a content corresponding thereto is displayed as shown in 2C. Like above, it is possible for the user to directly select the content through a shortcut method.

The link ranking method is a method that changes orders in accordance with the number of accesses, the used time, the used cycle, the used amount, or the like, based on the user's preferences.

FIG. 3a is a table showing a utilization ratio of users by each of contents in the wireless Internet.

A system computes the utilization ratio by users of each of contents menus, i.e. D1, E1, E2, F1, F2, and G1. As shown in the table, a first user has used 10% for F1, 20% for F2 and G1, and 50% for E2 respectively, without using D1 and E1, a second user has used 10% for E1, Fl, and G1, 20% for D1 and F2, and 30% for E2 respectively, and a third user has used 10% for G1, 20% for E1, E2, and F2, and 30% for Fl respectively without using D1. Accordingly, utilization ratios of each of contents by three users are in order of E2, F2, F1, G1, E1, and D1.

Like above, in case that an order is determined based on the utilization ratio of a user, the wireless Internet organizes menus in order according to the order thereof.

FIG. 3b is a diagram illustrating configuration of menus by a link ranking method in the wireless Internet.

In order to draw a user's convenience, contents are arranged in order according to the utilization ratios of users which have been determined like above. Therefore, contents are arranged in order of E2, F1, F2, G1, E1, and D1, and routes for getting access thereto are also rearranged. F for E2, F1, and F2 that are most used is placed prior to G in the same menu node. In addition, E E1 and E2 that is located in the same menu node, is placed prior to D for D1. Moreover, higher nodes B and C are also rearranged into C and B according to the utilization ratios thereof.

FIG. 3c are screens of mobile communication terminal showing procedures of getting access to a content through a link ranking method in the wireless Internet.

In case that a user gets access to the wireless Internet by using the mobile communication terminal, a menu screen by the first menu node is displayed as shown in 3A.

In the beginning, as shown in 1A in FIG 1b, menu nodes were in order of‘1. mail/photo/chatting’, ‘2. mybell/music’, ‘3. picture/photo/broadcasting’, and ‘4. game zone’. However, orders thereof have changed in order of ‘1. picture/photo/broadcasting’, ‘2. game zone’, ‘3. mail/photo/chatting’, and ‘4. my bell/music’, as shown in 3A. At this time, in case that the user selects ‘1. picture/photo/broadcasting’ including a content that the user wants, lower menu nodes are also rearranged based on utilization ratios, as shown in 3B and 3C.

Accordingly, in case that the link ranking method is used like above, the possibility goes up that a content mainly used by users is placed in an upper portion. Thus, a selection becomes more comfortable because there is no need to scroll down a screen so as to search for a content that the user wants.

However, like above, the shortcut method and the link ranking method have to go through several steps. Contents are arranged based on the entire users' preferences, not one user's personal preferences. Therefore, there is no guarantee that contents that the user wants are always located in an upper portion. In addition, it might cause inconvenience to a user who uses contents that other users hardly use. Accordingly, in order to solve the inconvenience like above, there is provided a method for manually generating a shortcut that a user wants, however, the user has tendency to consider it very tiresome because the user has to designate a shortcut menu one by one.

Moreover, the shortcut method and the link ranking method like above are arranged in the same contents, without regard to the time and location. Therefore, there is required a new method for facilitating access to particularly demanded contents with respect to the time or location, for a user who uses different contents in accordance with the time and location.

### BRIEF DESCRIPTION OF THE DRAWINGS

FIGS. 1a and 1b are drawings for explaining configuration of hierarchical menus of the general wireless Internet.

FIGS. 2a and 2b are drawings for explaining a shortcut method in configuration of menus of the wireless Internet.

FIGS. 3a, 3b, and 3c are drawings for explaining a link ranking method in configuration of menus of the wireless Internet.

FIG. 4 is a configuration diagram illustrating procedures of getting access to the wireless Internet through a mobile communication terminal.

FIG. 5 is a block diagram illustrating configuration of a system providing a personalized menu page according to the embodiment of the present invention.

FIG. 6 is a drawing for explaining a recommendation link method that is generated in a personalization recommendation engine unit.

FIG. 7 is a table for computing frequency of selections of each menu of menu page per time and per location according to one embodiment of the present invention.

FIGS. 8a and 8b are drawings for comparing the conventional menu page with a personalized menu page that is personalized and provided according to the present invention.

FIG. 9 is a flowchart for explaining procedures of providing a personalized menu page according to the present invention.

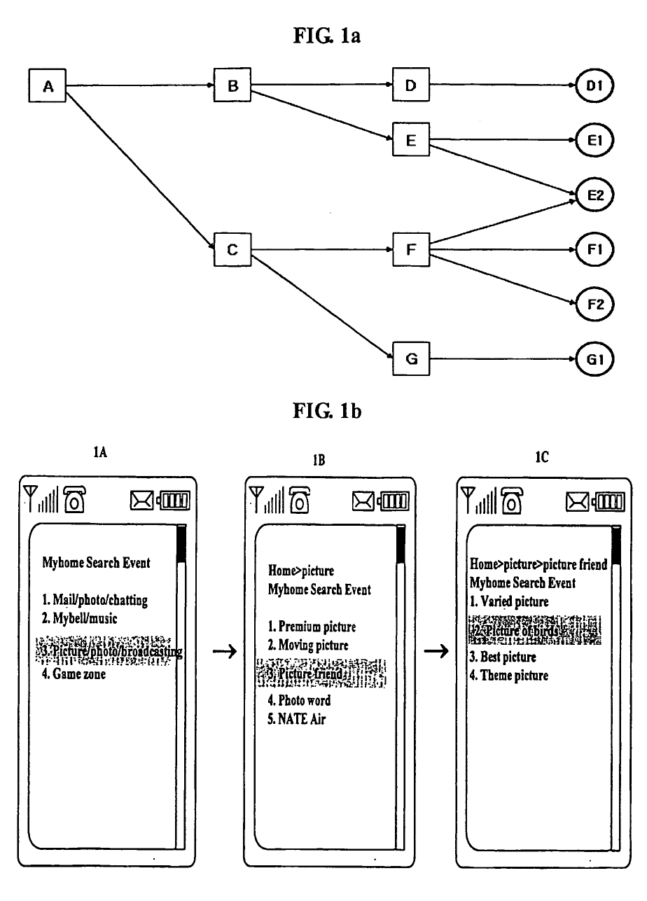

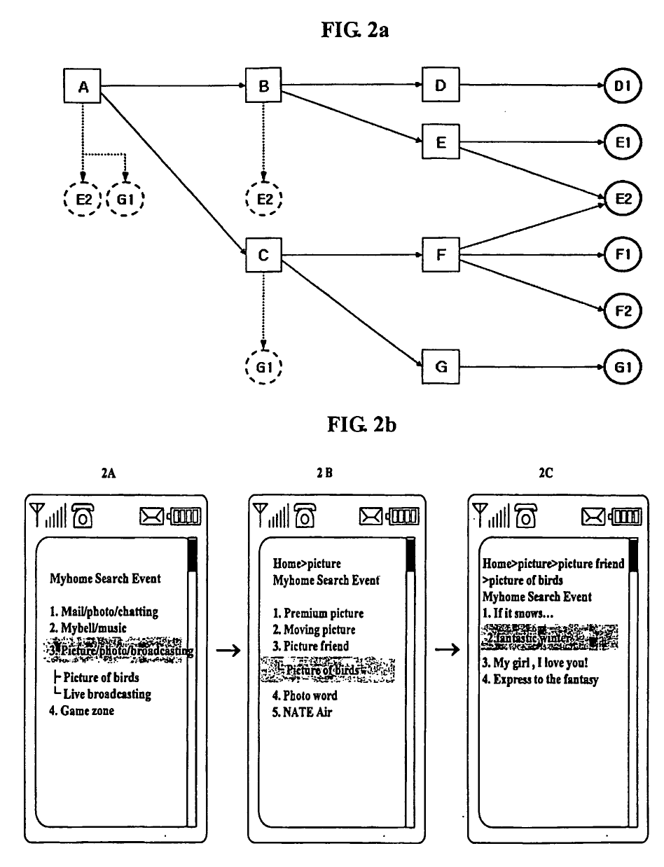

### DISCLOSURE OF THE INVENTION

### Technical Questions

In order to solve the aforementioned problems, in case that a user gets access to the wireless Internet by using a mobile communication terminal, the present invention provides system and method for providing a personalized menu page that has enhanced accessibility to a menu that the user uses frequently at the relevant location during the relevant time by grasping the user's time information and location information.

### Technical Solutions

In order to achieve the aforementioned object, the present invention comprises the steps of: maintaining a database including designated location information and a personalized menu page associated therewith, by users, wherein the personalized menu page includes at least one menu for selecting predetermined contents and the configuration of the menu is determined according to each user; in case that the user gets access to the wireless Internet by using a mobile communication terminal, grasping the user's current location; determining whether the user is at the designated location, by referring to the database; in case that it is determined that the user is at the designated location, searching the database for a personalized menu page associated with the designated location; and transmitting the searched personalized menu page to the mobile communication terminal.

In addition, the present invention provides a method for providing a personalized menu page, comprising the steps of: maintaining a database including a personalized menu page associated with a designated time and a designated location, by users, wherein the personalized menu page includes at least one menu for selecting predetermined contents and configuration of the menu is determined according to each user; in case that the user gets access to the wireless Internet by using a mobile communication terminal, grasping the accessed time and the user's current location; searching for a menu page associated with the accessed time and the current location, by referring to the database; and transmitting the searched page to the mobile communication terminal.

### BEST MODE FOR CARRYING OUT THE INVENTION

Hereinafter, the present invention will be described in detail with reference to the accompanying drawings. It should be noticed that reference symbols to components of each drawing are given, so that the same components may have the same symbols although the components are indicated on respectively different drawings. In addition, in case that it is determined that concrete description with respect to related common configuration or function might make the substance of the present invention indistinct, the detailed description related thereto is omitted.

A system for providing a personalized menu page according to the present invention obtains a user's location information by using terminal-based technology such as a GPS or network-based technology. In case that the user searches for information through the wireless Internet, the system reorganizes the personalized menu page into one having configuration of menus, the most suitable for the relevant time and location, and provides the user with the reorganized personalized menu page.

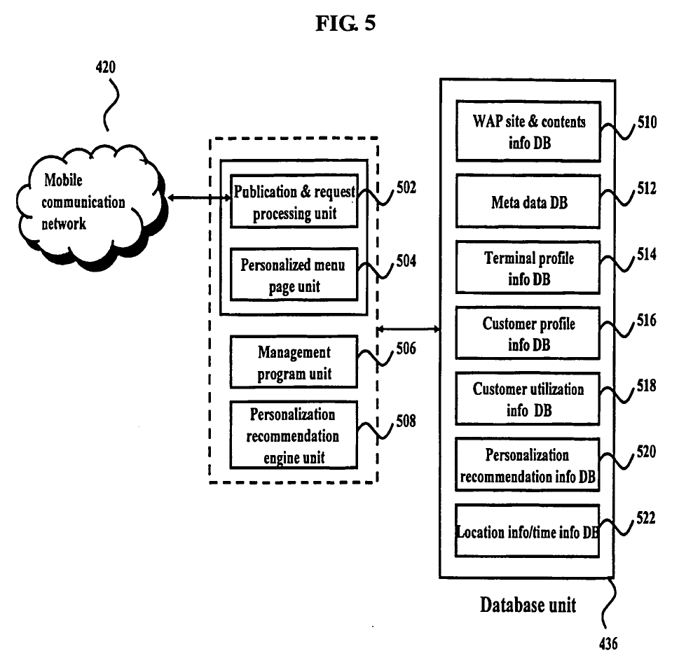

FIG. 4 is a configuration diagram illustrating procedures of getting access to the wireless Internet through a mobile communication terminal.

A system for getting access to the wireless Internet comprises a mobile communication terminal 410, a mobile communication network 420, the Internet 440 and a CP server 405, wherein the mobile communication network comprises a wireless switching point 422, an Inter-Working Function (hereinafter, ‘IWF’) 424, a WAP gateway 426, and an Wireless Internet Gateway (hereinafter, ‘WIG’) 430.

The mobile communication terminal 410 enables voice communication and data communication with a called party through the mobile communication network 420. The mobile communication terminal 410 gets access to the Internet 410 via the mobile communication network 420 by using a browser for Internet access, such as for example, Wireless Application Protocol (WAP) that is protocol for getting access to the wireless Internet, HTML-based Microsoft Internet Explorer (MIE) using HTTP protocol, Handheld Device Transport Protocol (HDTP), i-Mode of NTT DOKOMO company, ‘NATE’ of SK Telecommunication, or the like. Among Internet access protocol used by the mobile communication terminal 410, MIE adopts m-HTML in which HTML is a little transformed and abbreviated, and i-Mode adopts a language of compact HTML (c-HTML) that is a subset of HTML.

Examples of the mobile communication terminal 410 used in the present invention include a PDA (Personal Digital Assistant), a cellular phone, a PCS (Personal Communication Service) phone, a GSM (Global System for Mobile) phone, a W-CDMA (Wideband Code Division Multiple Access) phone, a CDMA-2000 phone, a MBS (Mobile Broadband system) phone, and the like. At this time, the MBS phone is a mobile phone that will be used in the fourth generation system.

The wireless switching point 422 receives information such as the latitude, the longitude, etc from a GPS, and transmits the received information to the mobile communication terminal 410, through a system parameter message of forward-link paging channel, thereby confirming location information of the mobile communication terminal 410. In addition, the wireless switching point 422 analyzes subscriber information and connects the mobile communication terminal 410 with IWF 424, so that the same 410 may get access to the wireless Internet. The wireless switching point 422 may include one piece of CGS (Central Gateway Switch) and a plurality of wireless switching points getting access thereto. However, only one piece of switching point is illustrated for brief indication.

The IWF 424 provides an interface for exchanging data between a wireless communication system and a wired communication system, and servers to convert protocol, signals and data into types suitable for each network.

The WAP gateway 426 serves to convert HTTP (HyperText Transfer Protocol) stack into WAP protocol stack, and inversely convert WAP protocol stack into HTTP stack. The WAP gateway 426 interoperates with the wired Internet through the WIG 430.

Furthermore, in configuring routes for accessing wireless Internet, a proxy server may be adopted instead of the WAP gateway 426. The proxy server serves to separately store information on a WAP site that a user visits frequently, and in case that the user gets access to the site, provide the information stored in the proxy server without going to a server of the WAP site, so as to avoid a traffic jam that occurs in providing information through the wireless Internet. The proxy server is used to improve the data transmission time by decreasing traffics of a network, and may prevent an unauthorized user from accessing by using a firewall function.

The WIG 430 comprises a DNS (Domain Name System) server 432, a WAP server 434, a database unit 436 and a WEB server 438.

The DNS server 432 maintains a database with respect to a domain name on the Internet and an IP address corresponding thereto. In addition, the DNS server 432 enables the IWF 424 or the WAP gateway 426 to get access to a CP server 450 through the wired Internet, by providing an IP address with respect to a domain name inquired by the IWF 424 or the WAP gateway 426.

The WAP server 434 organizes a menu for accessing the wireless Internet and provides the same for the mobile communication terminal 410 through the WAP gateway 426. Especially, according to the present invention, in arranging the access menu, the WAP server 434 automatically generates a personalized menu page that is optimized according to the location and time, based on information stored in the database unit 436, and provides each user with the generated personalized menu page. Rearrangement of the personalized menu page organized by the WAP server 434 like above is performed per period (e.g., one month or one week) set by a manager, or by a user. Therefore, the user can be continuously provided with the personalized menu page that is optimized for the user, depending on the user's utilization pattern. “The personalized menu page” according to the present invention includes a menu of user interface for selecting predetermined contents, and means a menu page in which menu configuration is determined by analyzing the user's utilization patterns by regions or time and reflecting the analyzed results.

The personalized menu page like above is a concept discriminating from “an individually designated menu page” in which the user directly designates menu configuration of a menu page provided thereto. The procedure of analysis like above is unnecessary in a procedure of generating the individually designated menu page.

The database unit 436 stores the user's individual information, i.e. the used time, a used amount, a used period, the user's menu preference (e.g., in case of selecting the menu, the user's preference with respect to contents that will be provided), or a time zone and location pre-set by the user.

In case that there is a demand from a wired client, the WEB server 438 provides contents maintained in the WIG 430 with the wired client through the wired Internet, in accordance with HTTP protocol.

The Internet 440 is a communication network providing an access route, so that the mobile communication terminal 410 may get access to the CP server 450 through the mobile communication network 420, so as to receive and transmit data.

The CP server 450 includes most of contents that are provided to the mobile communication terminal 410. Moreover, contents in a certain range may be maintained in the WIG 430, and the contents are directly transferred to the mobile communication terminal 410 through the WAP server 434.

Furthermore, the CP server 450 gets access to the WAP server 434 via the Internet 440 in order to provide contents. At this time, a part from the CP server 450 may be directly accessed by an exclusive line.

FIG. 5 is a block diagram illustrating configuration of a system providing a personalized menu page according to the embodiment of the present invention. The database unit 436 of FIG. 5 illustrates one example of data structure that may be adopted for arranging and providing the personalized menu page.

A system for providing a WAP page comprises a publication & request processing unit 502, a personalized menu page unit 504, a management program unit 506, a personalization recommendation engine unit 508 and the database unit 436, wherein the database unit 436 may comprise a WAP site & contents information DB 510, a meta data DB 512, a terminal profile information DB 514, a customer profile information DB 516, a customer utilization information DB 518, a personalization recommendation information DB 520 and a location information/time information DB 522.

The publication & request processing unit 502 serves to receive a request for processing of a menu page that includes a menu for selecting a content, from a user through the mobile communication network, and to produce a menu page of which menu configuration is processed for characteristics of the user's mobile communication terminal 410 and the user's request, so as to provide the same with the user. In the present specification, it is called as ‘publication’ to produce the menu page like using a markup language or the like. In addition, the publication and request processing unit 502 serves to generate and store log information record that is necessary for generating and analyzing the user's individual preferences.

The personalized menu page unit 504 serves to form and provide a menu page in such a way that the user's menu page utilization pattern, characteristics of the mobile communication terminal 410, recommendation information and the like are combined into dynamically changed page structure by using data of the database unit 436, in accordance with a request of the publication & request processing unit 502. Namely, the personalized menu page unit 504 serves to provide the dynamic personalized menu page based on the user's individual utilization particulars and characteristics thereof. In addition, in case that there is a user's request, the personalized menu page unit 504 serves to generate and provide the personalized menu page of which menu configuration is suitable for the user's location, by using the location information stored in the database unit 436, based on the user location information obtained from the mobile communication terminal 410.

The management program unit 506 forms basic structure of the WAP site to be searched by the user, and manages link information and page information with respect to the internal WAP site, screen configuration and design, and link information with contents providers (CP). In addition, the management program unit 506 is configured to set up options with respect to a personalized adaptation method, based on generation of reports with respect to the user's search record information, characteristics of the mobile communication terminal 410 such as the size of display, kinds of the terminal, the wireless Internet access speed and the like, and character of information.

The personalization recommendation engine unit 508 serves to generate a recommendation link by analyzing the user's utilization pattern and disposition through adaptation of some analysis algorithm and computing recommendation information for providing the user with correct information.

Moreover, in case that the user accesses through the wireless Internet, the personalization recommendation engine unit 508 serves to control the publication & request processing unit 502 to determine whether the accessed time is designated or whether the accessed location is designated, and in case that it is determined that the accessed time or location is designated, to provide the personalized menu page, and otherwise, to provide a general menu page.

The WAP site & content information DB 510 stores an address of the WAP page which is necessary for building the WAP site, structure of the WAP site which is formed of a DAG(Directed Acyclic Graph), and a name of the WAP page. WAP site information is dispersed not only to pages that are located in the unitary server, but also to a plurality of servers, thereby being connected to the contents WAP site of contents providers (CP). The WAP site & contents information DB 510 stores link information and WAP pages that are dispersed to severs like above, and information of other objects that exist within the WAP page.

The meta data DB 512 stores explanation with respect to the WAP page, classification information, the generated date, the corrected date, and the like, so as to facilitate management, search and analysis with respect to the WAP page.

The terminal profile information DB 514 stores browser information, the size of display, resolution, backup software environments, etc with respect to each mobile communication terminal 410 held by the user, and in case that personalization information is provided, serves to provide information suitable for the corresponding mobile communication terminal 410 by using the provided information.

The customer profile information DB 516 stores the user's subscription information and setup information, and the user's personal information such as a sex, an age, an occupation, and the like, by using a unique number that can recognize the user, i.e. a telephone number of the mobile communication terminal 410, the user ID or a serial number of the mobile communication terminal 410. At this time, terminal and customer profile information may be received through a rule such as CC/PP (Composite Capability and Preference Profile) or UAProf (User Agent Profile).

The customer utilization record DB 518 serves to analyze WAP page utilization record searched through the mobile communication terminal 410 of the user and store the analyzed record in a type suitable for the personalization.

The personalization recommendation information DB 520 serves to store personalization information generated through the personalization recommendation engine unit 508, and provide the personalization information to the personalized menu page unit 504.

The location information/time information DB 522 manages LID (Location ID) for indicating location information and TID (Time ID) for indicating time information. LID and TID are divided into a system designated value and a user designated value. At this time, the system designated LID is a value that the system has divided the whole country into the meaningful minimum unit, and the user designated LID is a value that each user has stored a region that is determined to be meaningful to the user. In addition, the system designated TID is a value that the system has divided 24 hours into the meaningful minimum unit, and the user designated TID is a time value that the user has set up for management.

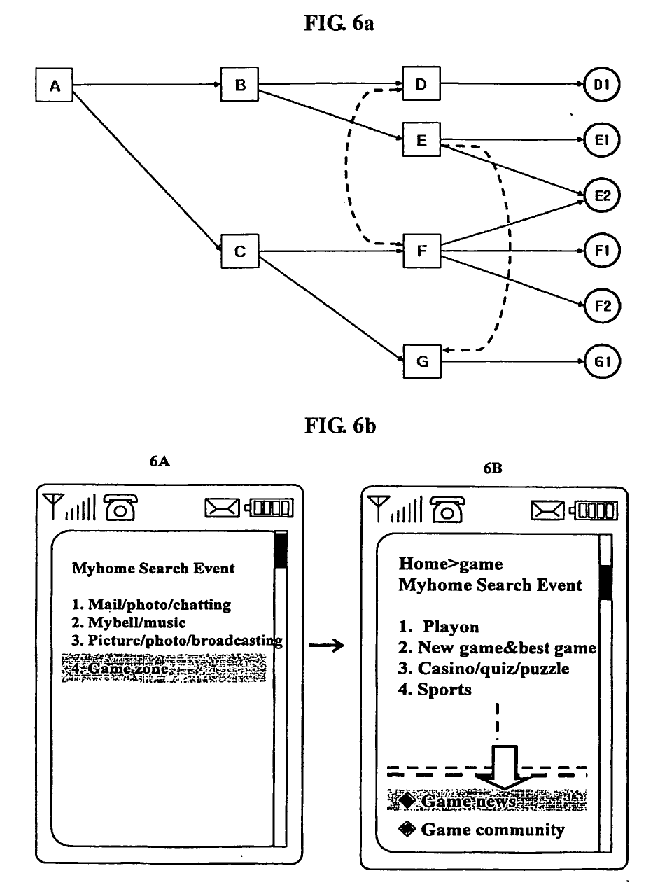

FIG. 6a is a diagram illustrating menu configuration by a recommendation link method generated in the personalization recommendation engine unit 508.

Generation of recommendation link may be performed in a menu configuration method in which users analyze the number of synchronous events of menu selections to be provided with predetermined contents, or find other menu used mainly by other homogeneous users who have selected a corresponding menu, analyze the menu, and give a priority thereto.

The personalization recommendation engine unit 508 analyzes the user's preferences or utilization pattern by using variety of algorithm such as information filtering algorithm like collaborative filtering or rules-based filtering based on similarity between page links, similarity between users, etc, reasoning algorithm like case-based reasoning, rules-based reasoning, etc, data mining algorithm like association rule, clustering, etc, and the like.

As illustrated in FIG. 6a, the recommendation link appears in such a way that a new link is connected between D and F, a link to F appears additionally when the menu screen of D is output, and on the contrary, a link to D appears when the menu screen of F is output. At this time, there is no direct link between D and F.

It is not that recommendation links should be bi-directionally formed between two menu nodes like D and F. As shown in relation between E and G, a unidirectional link may be formed. In this case, a unidirectional link is formed and developed only from E to G. Therefore, although a link to G is added to the menu screen when the menu screen of E is output, a link to E is not output when the menu screen of G is output.

FIG. 6b is screens of the mobile communication terminal for showing procedures of getting access to contents by the recommendation link method in the wireless Internet.

In case that the user accesses the wireless Internet by using the mobile communication terminal, a menu screen by the first menu node is displayed as illustrated in 6A, the user selects a directory including a content the user wants, by using a key pad of the mobile communication terminal. For example, in case that the user selects ‘4. game zone’ in the menu screen 6A, a lower menu screen of ‘4. game zone’ is displayed as illustrated in 6B. In addition, although they are not lower menus of ‘4. game zone’, ‘game news’ and ‘game community’ are displayed in the lower part of the menu screen, wherein the both are recommendation menus associated with ‘4. game zone’. Therefore, it is possible for the user to get access to a corresponding content by using the recommendation menus ‘game news’ or ‘game community’.

It is possible to provide the associated recommendation menus like 6B in FIG. 6b. Moreover, it is also possible to provide menus that users often use, as recommendation menus by analyzing the users who have used ‘4. game zone’ frequently.

Like above, the personalization recommendation engine unit 508 generates the recommendation link method, and a menu page is arranged thereby. At this time, it is possible to arrange menus by using only recommendation link method that has analyzed other users. In addition, it is also possible to arrange a menu page including a menu by the recommendation link method, a preference menu that a user accesses often personally, and an individual shortcut menu that is pre-set by the user.

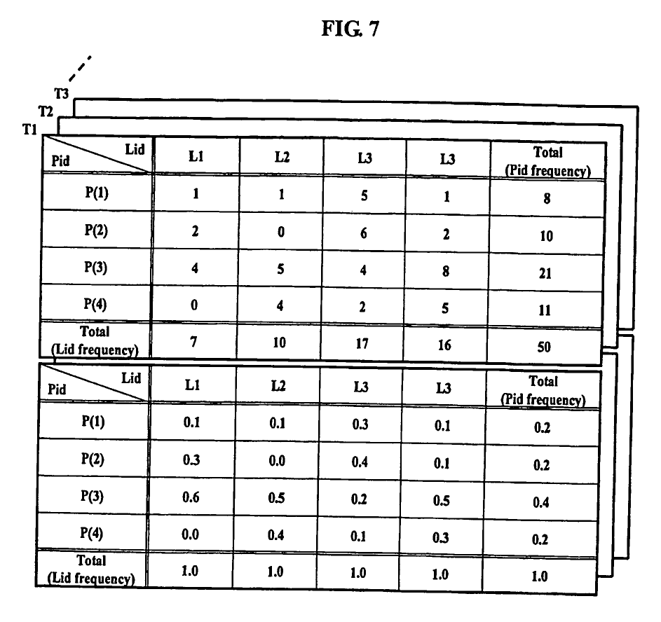

FIG. 7 is a table for computing frequency of selection of each menu of menu page per time and per location according to one embodiment of the present invention.

In case that a user's ID is UID and menu information selected by the user is PID, together with the aforementioned location identifier LID and time identifier TID, the system for providing a personalized menu page according to the present invention accumulates utilization preferences of PID, by TID, UID, and LID, wherein the PID was used by users in the past.

In the table of FIG. 7, each page is divided into pages of T1, T2, T3 . . . by TID. At this time, cross rows of the page by each TID are classified by LID and down lines are classified by PID.

In the certain time T1, a user has used P1 once, P2 twice, P3 four times and P4 zero, at the location of L1. Utilization ratios with respect thereto are respectively 10%, 30%, 60% and 0%, as shown in the table below.

The current state in which each menu has been used at the location of L2, P1 is once, P2 is zero, P3 is five times, and P4 is four time. Thus, each utilization ratio thereof is 10%, 0%, 50% and 40%. Like above, the number of utilization or utilization ratios is computed with respect to each of LID.

Furthermore, the present invention enables the user to designate the meaningful location and time zone. For example, in case that the user designates L2 as a particular location and gets access to the wireless Internet at the time T1 at the designated location L2, personalized menu pages are arranged in order of P3, P4, P1, and P2 which the user mainly uses. At this time, the meaningful location that the user can designate is not limited to one. That is, the user designates L2 as a residence place and L3 as a working place, and the user is at the residence place. In this case, it is possible to provide a personalized menu page according to L2. In addition, in case that the user is at the working place, it is possible to provide a personalized menu page according to L3. In case that the user is at a place besides the designated places, a general menu page according to a method for arranging recommendation links generated by the personalization recommendation engine unit, may be provided.

The term of the general menu page in the present specification means a menu page having common menu configuration with respect to a plurality of users or the entire users, which is unlike the personalized menu page that is generated by considering a user's disposition of menu selection at a predetermined time zone or location by users.

Furthermore, besides the method that the user designates a location, it is possible to provide the personalized menu page in which menus are arranged based on utilization ratios at the location where the user has accessed, and to provide the general menu page at the location where the user has not accessed before.

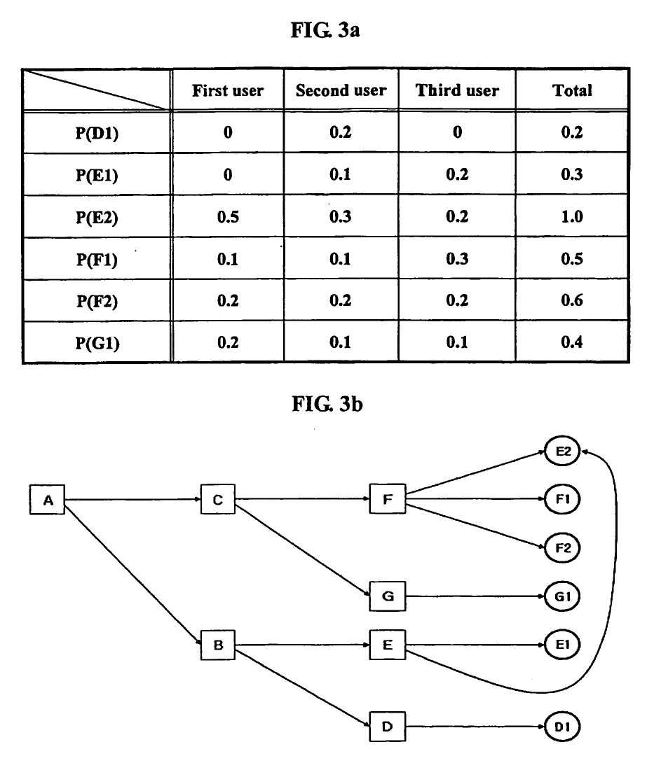

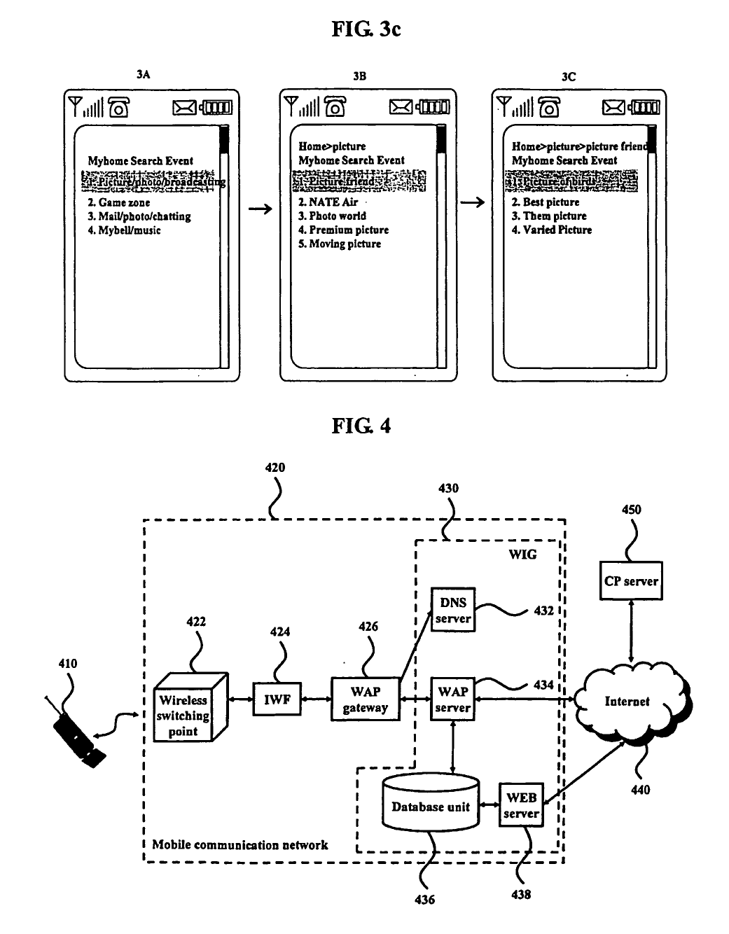

At this time, configuration of menu nodes according to the present invention is similar to FIG. 3b. However, the structure of menu nodes does not consist of one structure as shown in 3b, but consists of several menu nodes according to time and location. Therefore, there are several menu node structures according to the time and location, with respect to one person. For example, there may be comprised menu nodes of ‘(the number of designated time x the number of designated locations)+the number of designated time+the number of designated locations+1’. At this time, ‘the number of designated time×the number of designated locations’ is the number of personalized menu pages that are provided where the user is at the designated location and at the designated time. In addition, ‘the number of designated time’ is the number of personalized menu pages that are provided where the time is designated, however, the location is undesignated. ‘The number of designated locations’ is the number of personalized menu pages that are provided where the user is at the designated location at the undesignated time. Finally, ‘1’ means a menu page that is provided by the recommendation link method. In the meantime, the menu page according to each time and location is not pre-generated and stored, but generated dynamically in the personalized menu page unit 504 by reflecting the user's access states.

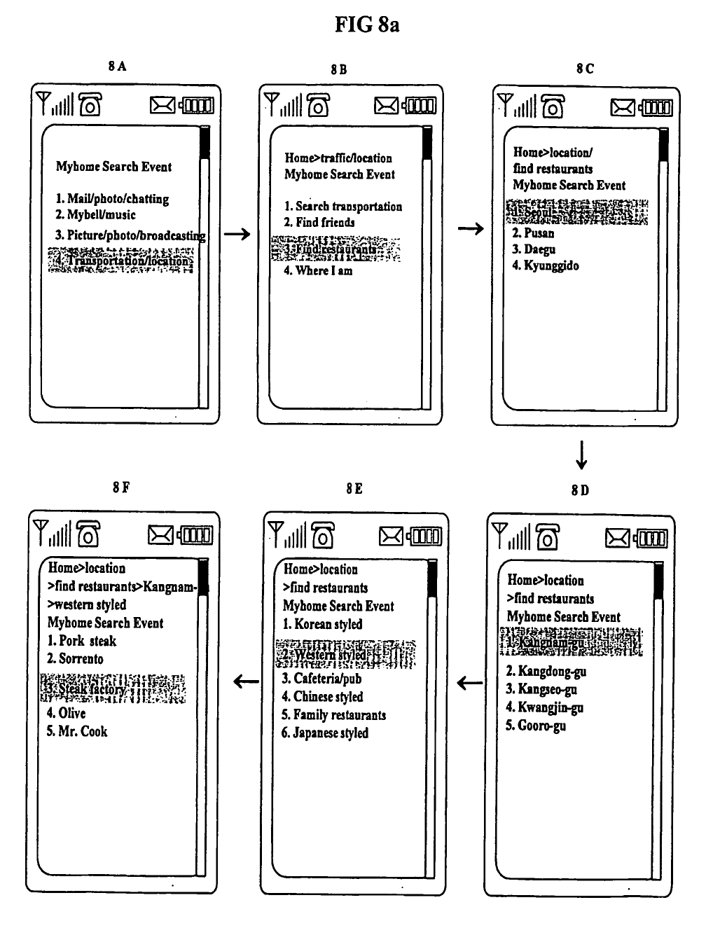

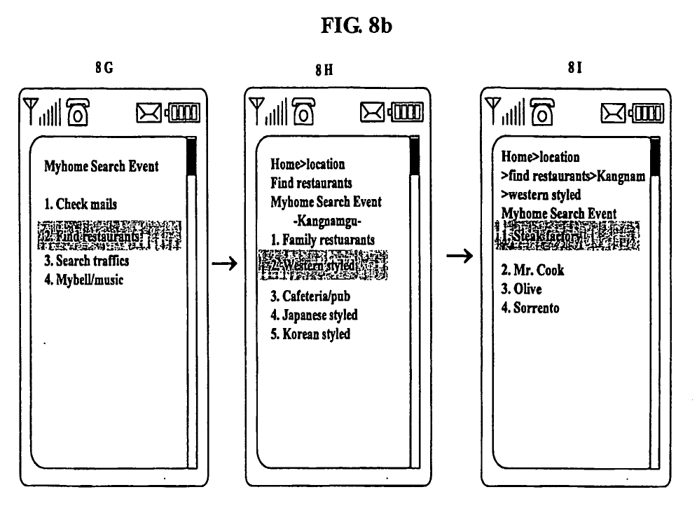

FIG. 8a is an example of screens for explaining a method of finding a restaurant using the mobile communication terminal according to the conventional configuration of menu pages.

In case that a user wants to find a western-styled restaurant in the region of Kangnam and accesses the wireless Internet through the mobile communication terminal 410, a menu screen as shown in 8A of FIG. 8 is displayed, and the user gets into a search window for traffic/location information of the corresponding region, through ‘4. traffic/location’ among menus. In case that the user enters the menu of ‘find restaurants’ in order to find out the restaurant at 8B of FIG. 8, the menu screen for selecting the relevant region is displayed as shown in 8C of FIG. 8. The user first selects ‘Seoul’ at cities and selects ‘Kangnam-gu’ at detailed regions through the step of 8D of FIG. 8. In case that the input is completed, the user selects a kind of restaurants through the screen of 8E of FIG. 8. In case that the user selects ‘2. western-styled’ restaurants, western-styled restaurants are displayed as shown in 8F of FIG. 8. In the end, the user can obtain contents information with respect to a corresponding restaurant by selecting one.

However, configuration of menu pages according to the present invention is simplified as illustrated in FIG. 8b.

In case that a user gets access to the wireless Internet at the pre-designated location, ‘Kangnam-gu’, configuration of menus is completed as shown in 8G of FIG. 8. The configuration of menus is set to give a priority to a menu that the user mainly uses at the particular location LID at the particular time TID.

The method for providing a menu page according to the present invention considers the user's disposition of selecting a predetermined menu at the designated location, and based thereon, generates a personalized menu page.

The disposition may be measured by user preferences. The user preferences may be computed by reflecting frequency that the user has selected a menu included in the personalized menu page, the service using time where the user is provided with a predetermined service (e.g., a game service, a music service, a search service, etc) by selecting the menu, the service charges to be paid by the user where the user is provided with the service.

According to embodiments, user preferences may be computed by reflecting any one of the frequency, the service using time, and the service charges. In the mean time, user preferences may be computed by considering the frequency and the like in combination.

According to one embodiment of the present invention, the personalized menu page unit 504 respectively computes the frequency with respect to the predetermined menu at the designated location during a certain period, the service using time, or the service charges, and computes user preferences with respect to the menu at the designated location, by giving weight to the frequency and the like.

Furthermore, according to another embodiment of the present invention, the weight may be for computing the relative frequency, the relative service using time, the relative service charges, or the like, in the relation between a predetermined menu and other menu. For example, the predetermined menu page provides three menus such as a first menu, a second menu, and a third menu and the user selects the first menu three times, the second menu twice, and the third menu five times. In this case, the relative frequency with respect to each of menus is 3/(3+2+5)=0.3 for the first menu, 2/(3+2+5)=0.2 for the second menu and 5/(3+2+5)=0.5 for the third menu.

Furthermore, according to another embodiment of the present invention, the weight may be for adjusting a unit difference between the frequency, the service using time, and the service charges.

Furthermore, according to another embodiment of the present invention, the weight may be for further reflecting any one of frequency, the service using time, and the service charges, in user preferences.

In the meantime, according to another embodiment of the present invention, the personalized menu page unit 504 may compute user preferences by using user preferences by unit periods in order to reflect the latest disposition that the user selects menus. Hereinafter, this will be in detail described.

First, the personalized menu page unit 504 computes user preferences by unit periods for each of menus. “User preference by unit periods” means user preferences that are computed by using frequency, service using time or service charges during the unit period. In case that the unit period is set by one day, the personalized menu page 504 computes the user preference every day. Therefore, today's user preferences by unit periods may be computed by respectively reflecting the number that the user has selected a relevant menu at the designated location during today, one day, the time that the user has used a service provided by selecting the menu, and charges that the user has to pay so as to use the service.

Furthermore, the personalized menu page unit 504 also computes user preferences per unit period, by using user preferences by unit periods that are newly computed per unit period. In case that the unit period is set by one day as aforementioned, and today is 30th of December, it is assumed that daily-computed user preferences by unit periods with respect to the predetermined menu are respectively 0.8 on 28th of December, 0.7 on 29th of December, and 0.5 on 30th of December.

At this time, in case that user preferences of 29th of December which had been computed with respect to the menu, were 0.8, the personalized menu page unit 504 may compute “user preferences of 30th of December” by using “that of 29th of December” and “user preferences by unit periods computed with respect to 30th of December”. At this time, the personalized menu page unit 504 may enable the user's latest disposition of menu selection to be further reflected, by giving more weight to the user preferences by unit periods of 30th of December.

For example, in case that user preferences which are computed currently are called as “current user preferences” and user preferences which had been computed just before are called as “former user preferences”, wherein current user preferences may be computed as below.

Current user preferences=(former user preferences×a)+(user preferences by the latest unit period×b)

Current user preferences computed as above is used for computing the following current user preferences, as former user preferences after the unit period passes. The personalized menu page unit 504 determines current user preferences as the aforementioned user preferences, wherein the current user preferences were computed in the last on the basis of the time of providing the user with a menu page.

The a and b are weighted values, and the personalized menu page unit 504 enables the latest disposition of selection of menus to be further reflected in user preferences by selecting a value of b to be larger in comparison with a.

In addition, the personalized menu page unit 504 computes user preferences by menus respectively, and gives a priority to each menu by reflecting user preferences computed like above. For example, a higher priority is given to a menu with higher user preferences.

Furthermore, the aforementioned embodiment has described where user preferences of each menu are computed at the designated location. However, according to another embodiment of the present invention, the personalized menu page unit 504 may compute user preferences of each menu at the designated location and time.

Furthermore, the personalized menu page unit 504 may arrange menus of the personalized menu page that are provided for the user, based on the priority.

For example, the personalized menu page unit 504 may enable a menu with a higher priority to be placed in the upper portion of the same menu page. In case that the priority order of “male/photo/chatting” menu is prior to that of “my bell/ music” menu, the personalized menu page unit 504 may enable the “mail/photo/chatting” menu to be placed in the upper portion in comparison with the “mybell/music” menu, as shown in 6A of FIG. 6.

Furthermore, the personalized menu page unit 504 may generate the personalized menu page, so that a menu with a higher priority may be located in a menu page with a lower depth of the menu. The personalized menu page may have at least one sub menu page with at least tow depths. For example, 6B of FIG. 6 is one of sub menu pages of 6A, and the depth of 6B is deeper than that of 6A by one. The personalized menu page unit 504 enables a user to get access to the menu easily, by placing the menu with a higher priority at a menu page with a lower depth.

Furthermore, with respect to a menu with a higher priority, the personalized menu page unit 504 may add a shortcut thereto, to a menu page with a depth lower than the existing location of the menu. For example, in case that the menu is located at a sub menu page with three depths, the personalized menu page unit 504 may add a short cut with respect to the menu, to a sub menu page with one depth. Accordingly, the user may select a shortcut displayed on the sub menu page with one depth, or the menu displayed on the sub menu page with three depths, thereby asking providing of content corresponding to the menu.

Furthermore, the personalized menu page unit 504 may indicate a menu with higher priority, in a different type from a menu with a lower priority. For example, the personalized menu page unit 504 may generate the personalized menu page, so that the menu with a high priority may be indicated in red and the menu with a low priority in black, at the same personalized menu page.

In case that the user selects one's wanted menu, i.e. “2. find restaurants”, the system for providing a personalized menu page displays a screen for selecting kinds of restaurants in the corresponding location, as shown in 8H of FIG. 8, so that the user may select one. The screen for selecting kinds of restaurants is also displayed in accordance with the ratio that the user has selected menus.

In case that the user selects one's wanted restaurant, lists of restaurants in the corresponding region are displayed according to ratios of selection of menus that the user has selected. The user selects a restaurant and searches for contents information.

Like above, according to the present invention, it is possible to reduce steps in searching for information through the wireless Internet using the mobile communication terminal. In addition, it is also possible to facilitate a selection of contents because a menu that used to be used most by the user's past utilization information is displayed in the upper portion of the personalized menu page.

Furthermore, the utilization ratio of menu according to the present invention may depend only on the user's individual past utilization information. However, it is also possible to provide a general menu page in a type of recommendation service at the location where the user has not set up, by using past utilization information that a group of users who have a similar disposition to the user, or the entire users have used at the particular location at the particular time zone.

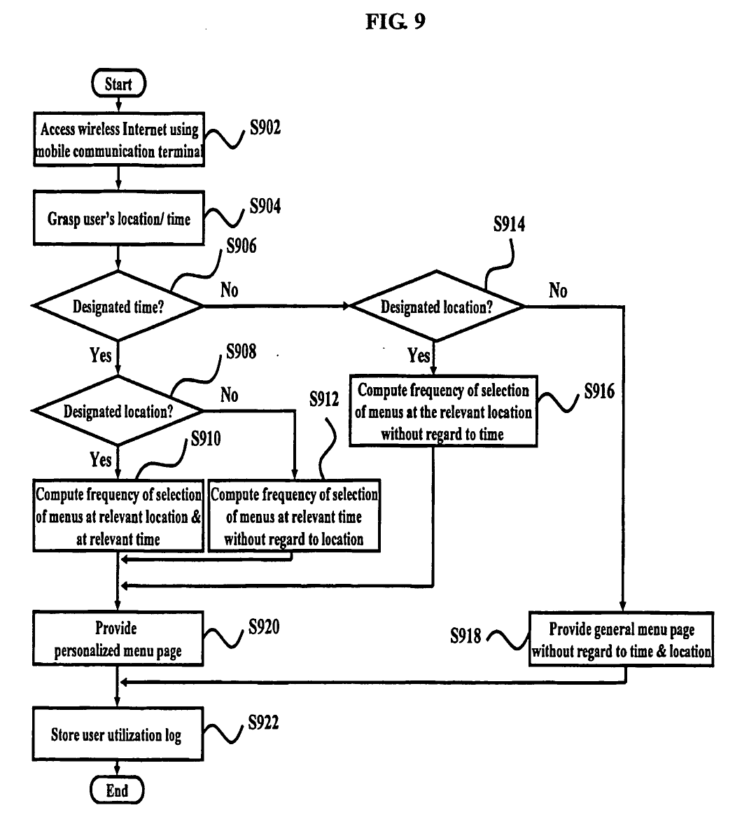

FIG. 9 is a flowchart for explaining procedures of providing a personalized menu page according to the present invention.

A user gets access to the wireless Internet through the mobile communication network 420, for the purpose of obtaining information via the mobile communication terminal 410 (S902). In case that the user gets access to the mobile communication network 420, location information is confirmed by obtaining information such as the latitude, the longitude, etc through a GPS, and time information is grasped through the wireless switching point 422 (S904).

In case that time information is confirmed, it is determined whether the time information corresponds to the time zone pre-designated by the user (S906). After confirmation of the time zone, the corresponding time zone is selected and it is determined whether the user's location corresponds to the pre-designated location (S908).

In case that the user searches for information at the designated location at the designated time, a personalized menu page is generated (S910), wherein the personalized menu page has configuration of menus based on frequency of selection of menus that the user has selected in order to be provided with predetermined contents at the relevant location at the relevant time. In case that the user asks a search of information at the designated time, however, at a place where the user has undesignated, the personalized menu page is generated by reflecting frequency of selection of menus at the relevant time without regard to the location (S912). The process of generating the personalized menu page by reflecting frequency of selection of menus and determining configuration of menus of the personalized menu page is as same as aforementioned.

At the results of steps S906 and S908, in case that it is determined that the user has asked a search of information at the designated location at the undesignated time (S914), the personalized menu page is generated by reflecting frequency of selection of menus at the relevant location without regard to the time (S916).

The personalized menu page generated in the steps S910, S912 and S916 is transmitted to the user's mobile communication terminal 410, so as to facilitate the user's search of information (S920). Accordingly, the user may be provided with the personalized menu page that is optimized for oneself, by times or by locations.

However, at the results of steps S906 and S914, in case that it is determined that neither time nor location is designated, the general menu page such as a menu page generated by a recommendation link, an individually-designated menu page, or the like, is provided to the user's mobile communication terminal 410 (S918).

In case that the user selects a menu included in the personalized menu page or the general menu page through the wireless Internet and is provided with contents corresponding to the selected menu, the system stores the user's log records and uses the same as data for computing frequency of selection of menus in case that there is the next request for access (S922).

The system computes utilization ratios with respect to individuals and the entire users through the above user utilization log and uses location information and time information, so as to organize configuration of the personalized menu page.

Furthermore, in the embodiment of the present invention, in case that the personalized menu page is organized only by using location information where the user is placed, without regard to the time, it is possible to omit steps S906 to S912.

Furthermore, although an example of providing a menu page such as the personalized menu page or the like to the WAP page is described in the aforementioned embodiment, this is only for an example. Thus, the menu page may be embodied as the WAP page by using a markup language. The scope of the present invention is not limited or restricted thereby.

Although the present invention has been described in connection with the embodiment of the present invention illustrated in the accompanying drawings, it is not limited thereto since it will be apparent to those skilled in the art that various substitutions, modifications and changes may be made thereto without departing from the scope and spirit of the invention. Therefore, it is intended that the scope of the invention be defined by the claims appended thereto and their equivalents.

### INDUSTRIAL APPLICABILITY

As aforementioned, according to the present invention, it is possible to provide a personalized menu page by users, wherein the personalized menu page has enhanced accessibility to a menu that a user mainly uses personally according to time and location, in comparison with other menus. In addition, in the user's position, it is possible to find one's wanted information faster.

Furthermore, even a user without utilization record of information with respect to a particular region and particular time zone, may be provided with a menu page which is useful, through information with respect to utilization records of the entire users, or a group of users who have a similar disposition to the user. Therefore, the user may easily find out information that the user wants, in searching for information through the wireless Internet.

Furthermore, in case of traffic information that a user searches for data at the synchronous location at the synchronous time zone, the present uniformed service is complicated and inconvenient. However, a personalized service according to the present invention may be easily used while driving a car, by simply obtaining necessary information according to the time zone and location. Therefore, it is possible to use the service conveniently.

1. A method for providing a menu page at a system for providing a personalized menu page, the method comprising the steps of:
maintaining a database including designated location information and a personalized menu page associated therewith, by users, wherein the personalized menu page includes at least one menu for selecting predetermined contents and the configuration of the menu is determined according to each user;
in case that the user gets access to the wireless Internet by using a mobile communication terminal, grasping the user's current location;
determining whether the user is at the designated location, by referring to the database;
in case that it is determined that the user is at the designated location, searching the database for a personalized menu page associated with the designated location; and
transmitting the searched personalized menu page to the mobile communication terminal.

2. The method of claim 1, wherein the personalized menu page is generated by performing the steps of:
computing the number of selection of menus by menus, wherein the number of selection of menus is the number that the user has selected menus included in the personalized menu page at the designated location;
giving a priority to each of menus by reflecting the computed number of selection of menus; and
determining configuration of menus that are included in the personalized menu page associated with the user, based on the priority by menus.

3. The method of claim 1, wherein the personalized menu page is generated by performing the steps of:
computing user preferences by menus, by using at least one of frequency that the user has selected menus included in the personalized menu page at the designated location, service using time with respect to a predetermined service that the user is provided by selecting the menu, or service charges to be paid according to providing of the service;
giving a priority to each of menus by reflecting the computed user preferences; and
determining configuration of menus that are included in the personalized menu page associated with the user, based on the priority by menus.

4. The method of claim 3, wherein said step of computing the user preferences by menus includes the step of computing the user preferences by respectively giving weight to the frequency, the service using time, or the service charges.

5. The method of claim 3, wherein said step of computing the user preferences by menus includes the steps of:
respectively computing frequency, service using time, or service charges, during a unit period;
computing user preferences during the unit period, by respectively giving weight to the frequency, the service using time, or the service charges, which are computed with respect to the unit period; and
giving weight to former user preferences and the user preferences during the unit period respectively, so as to compute current user preferences;
and after the unit period passes, the current user preferences are used as former user preferences with respect to a new unit period; and the user preferences are the current use preferences that are computed most recently.

6. The method of claim 1, wherein the designated location is a location selected by the user, or by the system for providing the personalized menu page.

7. A method for providing a menu page including a menu for selecting contents at a mobile communication terminal, the method comprising the steps of:
maintaining a database including a personalized menu page associated with a designated time and a designated location, by users, wherein the personalized menu page includes at least one menu for selecting predetermined contents and configuration of the menu is determined according to each user;
in case that the user gets access to the wireless Internet by using a mobile communication terminal, grasping the accessed time and the user's current location;
searching for a menu page associated with the accessed time and the current location, by referring to the database; and
transmitting the searched page to the mobile communication terminal.

8. The method of claim 7, further comprising the step of:
transmitting a general menu page to the mobile communication terminal, in case that a personalized menu page associated with the accessed time and the current location is not searched as a result of the search;
wherein the general menu page is a menu page having common configuration of menus with respect to a plurality of users or the entire users.

9. The method of claim 7, further comprising the step of:
transmitting an individually designated menu page to the mobile communication terminal, in case that a personalized menu page associated with the accessed time and the current location is not searched as a result of the search;
wherein the individually designated menu page is a menu page of which menus included therein are designated by the user.

10. The method of claim 7, wherein the personalized menu page is generated by performing the steps of:
computing user preferences by menus, by using at least one of frequency that the user has selected menus included in the personalized menu page at the designated location and at the designated time, service using time with respect to a predetermined service that the user is provided by selecting the menu, or service charges to be paid according to providing of the service;
giving a priority to each of menus, by reflecting the computed user preferences; and
determining configuration of menus included in the personalized menu page associated with the user, based on the priority by menus.

11. The method of claim 2, 3, or 10, wherein the configuration of menus includes at least one selected from a group consisting of:
(1) configuration enabling a menu with a higher priority to be placed in a higher rank;
(2) in case that a personalized menu page has a hierarchical menu structure including a sub menu page with at least two depths, configuration enabling a menu with a higher priority to be located at a page whose depth is low;
(3) in case that a personalized menu page has a hierarchical menu structure including a sub menu page with at least two depths, configuration adding a shortcut with respect to the menu with a higher priority, to a page whose depth is lower than the existing location of said menu with a higher priority; or
(4) configuration indicating a menu with a higher priority in a different type from a menu with a lower priority.

12. The method of claim 2 or 10, wherein said step of giving a priority to each of menus by reflecting the computed number of selection of menus comprises:
a first step of respectively computing the number of selection of menus during a past predetermined period, based on the present time; and
a second step of giving a priority to a menu of which the number of selections is larger; and
the first step and the second step are periodically performed.

13. A computer readable record medium recording a program for implementing the method of any one of claims 1 to 10.

14. A system for providing a personalized menu page including a menu for selecting contents at a mobile communication terminal, the system comprising:
in case that a request for providing of a menu page is received from the mobile communication terminal, a publication & request processing unit for selectively providing any one of a personalized menu page or a general menu page, to the mobile communication terminal;
a personalized menu page unit for (1) computing the number of selection of menus at a predetermined designated time and at a predetermined designated location according to each user, by menus, (2) generating a personalized menu page whose configuration of menus is determined based on said number of selection of menus, and (3) recording the generated personalized menu page in a predetermined database, in association with the designated time and the designated location; and
a personalization recommendation engine unit for (1) determining a current location of the mobile communication terminal and the time when the request for providing of the menu page is received, (2) searching for a personalized menu page associated with the current location and the received time, by referring to the database, (3) controlling the publication & request processing unit to provide the searched personalized menu page in case that the personalized menu page is searched as a result of the search, and provide a general menu page in case that the personalized menu page is not searched as a result of the searched ,to the mobile communication terminal.

15. The system of claim 14, wherein the designated location or the designated time is a location or time designated by a user who is provided with the personalized menu page.
